(19) United States
(12) Patent Application Publication
(10) Pub. No.: US 2002/0144907 A1
(43) Pub. Date: Oct. 10, 2002

(54) Apparatus and method of introducing a sample in a microchip electrophoresis

(75) Inventor: Rintaro Yamamoto, Kyoto-shi (JP)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(73) Assignee: SHIMADZU CORPORATION, Kyoto-shi (JP)

(21) Appl. No.: 10/118,178

(22) Filed: Apr. 8, 2002

(30) Foreign Application Priority Data
Apr. 9, 2001 (JP) 2001-110106

(51) Int. Cl. G01N 27/26; G01N 27/447

(52) U.S. Cl. 204/453; 204/604

(57) ABSTRACT

An end of a capillary storing a sample in its interior is inserted into a sample reservoir in a microchip and positioned near an inlet of a channel connecting to the sample reservoir. Electrodes are placed in the other end of the capillary and a waste reservoir. A predetermined voltage is applied between the electrodes so that a potential is applied between the other end of capillary and waste reservoir. As a result, the sample in the capillary is introduced electrophoretically into a separating medium in the channel. When the sample has been introduced into the channel after the lapse of a specified time, the voltage application between the electrodes is stopped and the capillary is pulled out of the sample reservoir. The sample can be introduced into the channel without placing it in the sample reservoir in a filling amount.

### BACKGROUND OF THE INVENTION

This invention relates to an apparatus and a method of introducing a sample in a microchip electrophoresis in which a microchip having a channel formed in an interior of a planar substrate and reservoirs formed in positions corresponding to opposite ends of the channel is used with the channel and the reservoirs being filled with a migration medium, such that the sample is electrophoresed within the channel.

Microchip electrophoresis is typically used to achieve fast and high-resolution analysis of samples containing extremely small amounts of proteins, nucleic acids, drugs, etc.

Microanalysis of proteins, nucleic acids, etc. has been effected by electrophoresis techniques, among which a capillary electrophoresis may be mentioned as a representative example. In the capillary electrophoresis, a glass capillary (hereunder referred to simply as a “capillary”) that has an inside diameter of no more than 100 micrometers is used. The glass capillary is filled with a separating medium and a sample is introduced at an end of the capillary. With both ends of the capillary placed in contact with a running buffer, high voltage is applied between the two ends of the capillary via the running buffer so that the analytes in the sample are resolved in the capillary. Since the capillary has a large surface area for a given capacity (i.e., can be cooled with high efficiency), sufficiently high voltage can be applied that very small amounts of samples such as DNA (deoxyribonucleic acid) can be analyzed at high speed and in high resolution.

A problem with this technique is that the capillary which is as thin as about 100-500 μm will break easily, presenting the user with difficulty in handling during capillary replacement. Occasionally, heat dissipation is insufficient and separation efficiency is adversely affected. As a further problem, in order to apply voltage to its opposite ends via the running buffer, the capillary must at least have the length necessary to contact the running buffer at both ends and it cannot be designed shorter than a certain length.

As a capillary substitute that has a potential to permit faster analysis with a smaller apparatus, a microchip (electrophoresis chip) formed of two joined substrates has been proposed in D. J. Harrison et al., Anal. Chem. 1993, 283, 361-366. An example of the microchip is shown in FIGS. 2A-2C. A microchip 1 comprises a pair of substrates 1a and 1b in transparent plate form which are made of an inorganic material (e.g. glass, quartz or silicon) or a plastic material. Two crossed migration capillary grooves (channels) 3 and 5 are formed in the surface of one substrate 1b by photolithography, micromachining or other techniques commonly employed in the semiconductor fabrication process. An anode reservoir 7a, a cathode reservoir 7c, a sample reservoir 7s and a waste reservoir 7w are formed as through-holes in the other substrate 1a in positions that correspond to the ends of the channels 3 and 5. The microchip 1 is used with the substrate 1a superposed on the substrate lb as shown in FIG. 2C.

As a preliminary step in electrophoresis analysis with the microchip 1, a separating medium is forced into any one of the reservoirs, for example, the anode reservoir 7a by a suitable pumping means such as a syringe until it fills the channels 3 and 5 and the reservoirs 7a, 7c, 7s and 7w. Then, the separating medium in the reservoirs 7a, 7c, 7s and 7w is eliminated and a sample is injected into the sample reservoir 7s which corresponds to one end of the shorter channel (sample injection channel) 3 and a running buffer is injected into the other reservoirs 7a, 7c and 7w.

The microchip 1 injected with the separating medium, the sample and the running buffer is set in an electrophoresis apparatus. Predetermined voltages are applied to the reservoirs 7a, 7c, 7s and 7w so that the sample migrates through the channel 3 until it reaches the intersection 9 of the two channels 3 and 5. The voltages on the reservoirs 7a, 7c, 7s and 7w are switched such that the voltage between the reservoirs 7a and 7c at opposite ends of the longer channel (separating channel) 5 causes the sample in the intersection 9 to be introduced electrophoretically into the channel 5.

After introducing the sample into the channel 5, instability elements in electrophoresis due to the difference in electrolytic conductivity between the solutions in the reservoirs 7a, 7c, 7s and 7w are eliminated by replacing the sample in the reservoir 7s with the same running buffer as is stored in the reservoirs 7a, 7c and 7w.

Then, an electrophoresis voltage is applied to the reservoirs 7a, 7c, 7s and 7w so that the sample injected into the channel 5 is separated into respective components in the channel 5. The electrophoretically separated components in the sample are detected and analyzed with a detector provided at an appropriate position in the channel 5. Detection methods include absorption photometry, fluorometry, electrochemistry and the electrical conductance approach.

This method of introducing samples is called the “cross-injection” method. In the above explanation of the cross-injection method, the running buffer is stored in the reservoirs 7a, 7c and 7w and in the sample reservoir 7s after the sample is replaced. If desired, the separating medium may be stored instead of the running buffer.

Another example of the microchip is shown in FIGS. 3A-3C. A microchip 11 comprises a pair of substrates 11a and 11b in transparent plate form which are made of an inorganic material (e.g. glass, quartz or silicon) or a plastic material. A migration capillary groove (channel) 13 is formed in the surface of one substrate 11b by photolithography, micromachining or other techniques commonly employed in the semiconductor fabrication process. A sample reservoir 15s and a waste reservoir 15w are formed as through-holes in the other substrate 11a in positions that correspond to the ends of the channel 13. The microchip 11 is used with the substrate 11a superposed on the substrate 11b as shown in FIG. 3C.

As a preliminary step in electrophoresis analysis with the microchip 11, a separating medium is forced into any one of the reservoirs, for example, the sample reservoir 15s by a suitable pumping means such as a syringe until it fills the channel 13 and the reservoirs 15s and 15w. Then, the separating medium in the reservoirs 15s and 15w is eliminated, and a sample is injected into the sample reservoir 15s and a running buffer is injected into the waste reservoir 15w.

The microchip 11 injected with the separating medium, the sample and the running buffer is set in an electrophoresis apparatus. A predetermined voltage is applied to the reservoirs 15s and 15w so that the sample is introduced into the channel 13.

After introducing the sample into the channel 13, instability elements in electrophoresis due to the difference in electrolytic conductivity between the solutions in the reservoirs 15s and 15w are eliminated by replacing the sample in the reservoir 15s with the same running buffer as is stored in the reservoir 15w.

Then, an electrophoresis voltage is applied to the reservoirs 15s and 15w so that the sample injected into the channel 13 is separated into respective components in the channel 13. The electrophoretically separated components in the sample are detected and analyzed with a detector provided at an appropriate position in the channel 13.

This method of introducing samples is called the “electrokinetic” method. In the above explanation of the electrokinetic method, the running buffer is stored in the waste reservoir 15w, and in the sample reservoir 15s after the sample is replaced. If desired, the separating medium may be stored instead of the running buffer.

Whether samples are introduced in microchip electrophoresis by the electrokinetic method or the cross-injection method, the sample stored in the sample reservoir must eventually be replaced by the same solution (separating medium or the running buffer) as in the other reservoirs. This replacement of the solution within the sample reservoir is a time-consuming step. In addition, bubbles may potentially form during replacement of the solution within the sample reservoir.

As a further problem, in order to ensure that the process of electrophoresis is not interrupted by drying-up of the solution in the sample reservoir, the capacity of the sample reservoir has to be adequately large. In the related art methods of sample introduction, the sample volume must be commensurate with the capacity of the sample reservoir and this has put a limit on the efforts to reduce the sample volume.

### SUMMARY OF THE INVENTION

An object of the invention is to provide an apparatus and a method of introducing samples in microchip electrophoresis by which a sample can be introduced into a channel without placing it in a reservoir in a microchip in a filling amount.

This object of the invention can be attained by a method of introducing a sample in a microchip electrophoresis in which a microchip having a channel formed in an interior of a planar substrate and reservoirs formed in positions corresponding to opposite ends of the channel is used with the channel and reservoirs being filled with a migration medium such that the sample is electrophoresed within the channel. In the method of injecting the sample in the microchip electrophoresis, an end of a capillary storing the sample is inserted into one of the reservoirs in the microchip which is filled with the migration medium in the channel and the reservoirs. Then, the sample stored in the capillary is introduced electrophoretically into the channel by applying a voltage between the other end of the capillary and the reservoir communicating via the channel with the reservoir into which the capillary is inserted.

The term “migration medium” as used herein includes a separating medium and a running buffer, as well as other mediums through which the sample migrates.

According to the present invention, an end of the sample-storing capillary is inserted into any one of the reservoirs in the microchip which is filled with the migration medium in the channel and the reservoirs. The sample stored in the capillary is introduced electrophoretically into the channel by applying a voltage between the other end of the capillary and the reservoir communicating via the channel with the reservoir into which the capillary is inserted. Thus, in the invention, the sample is introduced into the channel without placing it in the reservoir in the microchip in a filling amount. When we say “the sample is stored in a reservoir in the microchip in a filling amount”, the meaning is not limited to the case of filling the sample to the full capacity of the reservoir but includes the case of placing the necessary volume of the sample within the reservoir. After pulling the capillary out of the reservoir, the introduced sample is electrophoresed for separation into components.

Preferably, an end of the capillary is positioned within the reservoir near the inlet of the channel. As a result, one can suppress the diffusion of the sample within the reservoir as it migrates through the capillary from an end of it toward the channel.

### BRIEF DESCRIPTION OF THE DRAWINGS

FIG. 1 shows a microchip as section X-X of FIGS. 2A-2C;

FIG. 2A is a top view of one of two substrates comprising an example of the microchip;

FIG. 2B is a top of the other substrate;

FIG. 2C is a side view of the two substrates, one put on the other;

FIG. 3A is a top view of one of two substrates comprising another example of the microchip;

FIG. 3B is a top of the other substrate; and

FIG. 3C is a side view of the two substrates, one put on the other.

### DESCRIPTION OF THE PREFERRED EMBODIMENTS

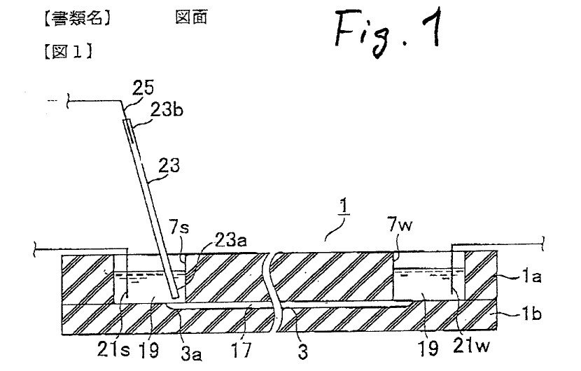

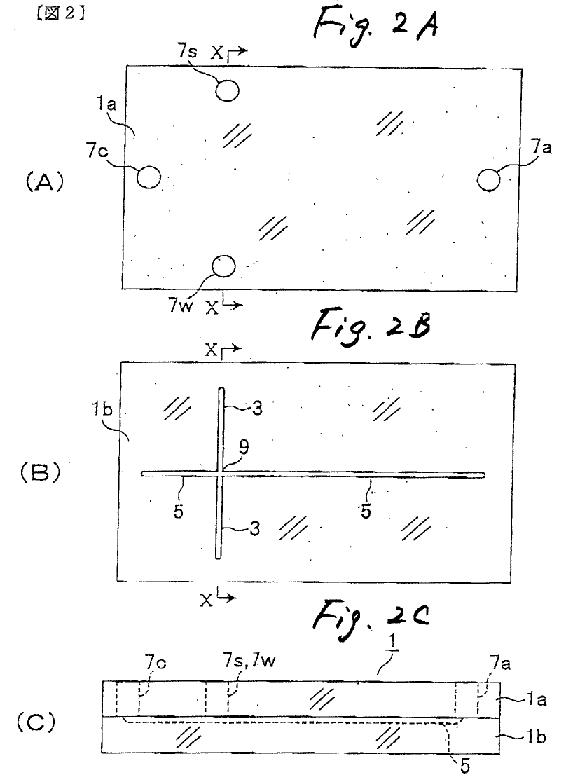

FIG. 1 is a sectional view of a microchip of the invention and it shows section X-X of FIGS. 2A-2C. Using FIGS. 1 and 2A-2C, we now describe an operating procedure for the method of the invention for introducing sample in microchip electrophoresis.

First, channels 3 and 5 in a microchip 1 are filled with a separating medium 17 and then reservoirs 7a, 7c, 7s and 7w are filled with a running buffer 19. Electrodes 21s and 21w are stored respectively in the reservoirs 7a, 7c, 7s and 7w to be in contact with the running buffer 19 in the reservoirs 7a, 7c, 7s and 7w. The electrodes connected to the reservoirs 7a and 7c are not shown in FIG. 1.

A sample is stored within a capillary 23. The capillary 23 is made of a non-conductive material such as glass or a resin and has an outside diameter of 250-365 μm, an inside diameter of 50-100 μm, and a length of 50-70 mm. In this embodiment, the capillary 23 has an outside diameter of 365 μm, an inside diameter of 100 μm, and a length of 50 mm. An end 23a of the capillary 23 is inserted into the sample reservoir 7s and positioned near an inlet 3a of the channel 3 connecting to the sample reservoir 7s. An electrode 25 is placed in the other end 23b of the capillary 23.

Predetermined voltages are applied between the electrodes 21w and 25 and between the electrodes connected to the reservoirs 7a and 7c so that a potential is applied between the other end 23b of the capillary 23 and the waste reservoir 7w. As a result, the sample in the capillary 23 is introduced electrophoretically into the separating medium 17 in the channel 3 via the running buffer 19 in the sample reservoir 7s. When the sample has been introduced into the channel 3 after the lapse of a specified time, the voltage application between the electrodes 21w and 25 and between the electrodes connected to the reservoirs 7a and 7c is stopped and the capillary 23 is pulled out of the sample reservoir 7s. The subsequent procedure is the same as in the related art process of resolution by electrophoresis.

Thus, in the embodiment just described above, the sample can be introduced into the channel 3 without placing it in the sample reservoir 7s in a filling amount. Since this eliminates the need for solution replacement in the sample reservoir 7s, one can not only realize the saving of the time that would otherwise be taken by the step of solution replacement but also avoid the risk of bubble formation and transfer into the sample reservoir 7s during solution replacement.

In the related art method of sample introduction, the sample must be stored in the sample reservoir in a volume commensurate with its reservoir and this has put a limit on the efforts to reduce the sample volume. According to the embodiment of the invention described above, the required sample volume can be reduced by using a capillary of small capacity.

In the foregoing embodiment, the running buffer is stored in the reservoirs 7a, 7c, 7s and 7w but this is not the sole case of the invention and other migration mediums may be employed, as exemplified by the same separating medium as what is stored in the channels 3 and 5.

In the embodiment, the end 23a of the capillary 23 is positioned near the inlet 3a of the channel 3 but this is not the sole case of the invention and the end 23a may be positioned anywhere in the migration medium stored in a reservoir. It is, however, preferred that an end of the microchip is positioned near the inlet of the channel.

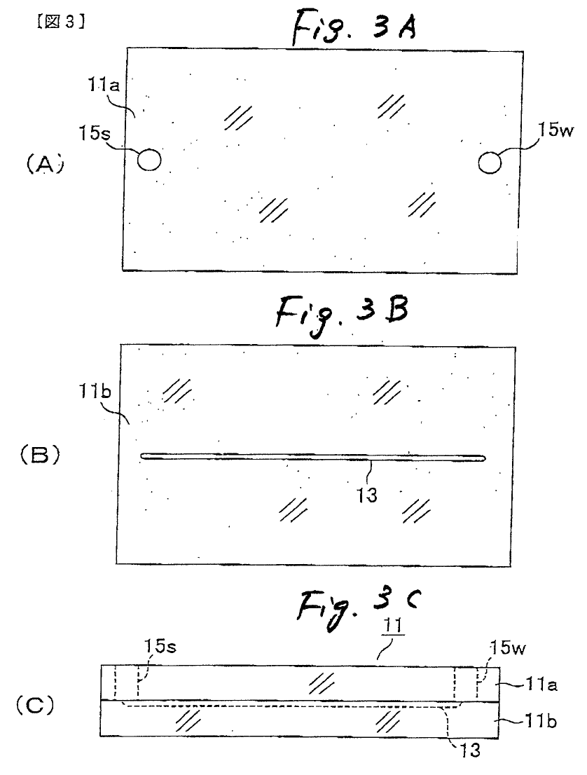

The microchip to be used in the invention is not limited to the type shown in FIGS. 2A-2C and a microchip 11 in FIGS. 3A-3C and may also be used since it has reservoirs formed in positions corresponding to opposite ends of a channel formed in the interior of a planar substrate.

In the method of the invention for sample introduction, an end of the sample-storing capillary is inserted into any one of the reservoirs in the microchip which is filled with the migration medium in the channel and the reservoirs. Then, the sample stored in the capillary is introduced electrophoretically into the channel by applying a voltage between the other end of the capillary and the reservoir communicating via the channel with the reservoir into which the capillary is inserted. Thus, the sample can be introduced into the channel without placing it in a reservoir in a filling amount. This eliminates the need for solution replacement in the reservoir that is routine in the related art after the sample has been introduced into the channel. Therefore, one can not only realize the saving of the time that would otherwise be taken by the step of solution replacement but also avoid the risk of bubble formation and transfer into the reservoir during solution replacement. In the related art method of sample introduction, the sample must be stored in a reservoir in a volume commensurate with its reservoir and this has put a limit on the efforts to reduce the sample volume. However, according to the present invention, the required sample volume can be reduced by using a capillary of small capacity.

If an end of the capillary is positioned in the reservoir near the inlet of the channel, one can suppress the diffusion of the sample within the reservoir as it migrates through the capillary from an end thereof toward the channel.

What is claimed is:

1. A method of introducing a sample in a microchip electrophoresis in which a microchip having a channel formed in an interior of a planar substrate and reservoirs formed in positions corresponding to opposite ends of the channel is used with the channel and reservoirs being filled with a migration medium such that the sample is electrophoresed within the channel, the method comprising:
inserting an end of a capillary storing a sample into one of the reservoirs in the microchip which is filled with the migration medium in the channel and the reservoirs; and
introducing the sample stored in said capillary electrophoretically into the channel by applying a voltage between the other end of said capillary and the reservoir communicating via the channel with the reservoir into which said capillary is inserted.

2. The method according to claim 1, wherein the end of said capillary is positioned within the reservoir near an inlet of said channel.

3. An apparatus of introducing a sample in a microchip electrophoresis, the apparatus comprising:
a microchip having a channel formed in an interior of a planar substrate and reservoirs formed in positions corresponding to opposite ends of the channel, the channel and the reservoirs being filled with a migration medium;
a capillary having a sample stored therein and having an end of the capillary to be inserted into one of the reservoirs in the microchip which is filled with the migration medium in the channel and the reservoirs; and
two electrodes respectively disposed in the other end of said capillary and the reservoir communicating via the channel with the reservoir into which said capillary is inserted.
